(19) United States
(12) Patent Application Publication
(10) Pub. No.: US 2026/0008497 A1
(43) Pub. Date: Jan. 8, 2026

(54) SUSPENSION COUPLING STRUCTURE

(71) Applicants: HYUNDAI MOTOR COMPANY, Seoul (KR); KIA CORPORATION, Seoul (KR)

(72) Inventors: Ha Kyung Moon, Hwaseong-si (KR); Tae Sic Park, Hwaseong-si (KR); Chon Ok Kim, Hwaseong-si (KR); Baek Yu Kim, Hwaseong-si (KR); Jun Hoi Huh, Hwaseong-si (KR); Jeong Woo Park, Hwaseong-si (KR); Tal Chol Kim, Hwaseong-si (KR); Buhm Joo Suh, Hwaseong-si (KR)

(73) Assignees: HYUNDAI MOTOR COMPANY, Seoul (KR); KIA CORPORATION, Seoul (KR)

(21) Appl. No.: 18/961,008

(22) Filed: Nov. 26, 2024

(30) Foreign Application Priority Data
Jul. 3, 2024 (KR) 10-2024-0087214

(51) Int. Cl. B62D 7/18; B60G 3/20; B60G 15/06; B62D 5/04; B62D 7/10; B62D 17/00

(52) U.S. Cl. CPC B62D 7/18; B60G 3/20; B60G 15/06; B62D 5/0418; B62D 7/10; B62D 17/00; B60G 2200/14; B60G 2202/30; B60G 2204/416; B60G 2800/162

(57) ABSTRACT

A suspension coupling structure includes: a lower arm including a first end coupled to a vehicle body, an upper arm coupled to an upper end of a fixed knuckle, a rotating knuckle located at a lower end of the fixed knuckle and an upper end of the lower arm and configured to be rotatably coupled to a wheel of a vehicle, a steering input part fixed to the fixed knuckle and configured to apply a steering force to the rotating knuckle, and a toe link configured to couple the fixed knuckle to the vehicle body.

### CROSS-REFERENCE TO RELATED APPLICATION

This application claims, under 35 U.S.C. § 119 (a), the benefit of and priority to Korean Patent Application No. 10-2024-0087214, filed on Jul. 3, 2024, the entire contents of which are incorporated herein by reference.

### BACKGROUND

### (a) Technical Field

The present disclosure relates to a suspension coupling structure, and more particularly, to a suspension coupling structure to allow each wheel of a vehicle to perform independent steering in response to a steering input signal.

### (b) Background Art

A vehicle has a suspension provided therein and configured to mitigate vibration generated between wheels and the road surface. Specifically, the suspension is provided at a portion of the vehicle where the wheels are installed.

Among various types of suspensions, a suspension suitable for each vehicle type is selected and installed in the vehicle.

As one example of the suspension, a MacPherson suspension is described with reference to FIG. 1.

The MacPherson suspension includes a knuckle 11, a shock absorber 12 provided on the upper portion of the knuckle 11 and configured to absorb vibration, a lower arm 13 connected to the lower portion of the knuckle 11, and a stabilizer 14 connected to the lower portion of the knuckle 11 or the lower portion of the shock absorber 12.

The knuckle 11 includes a wheel mount part having a wheel W installed at a center portion thereof, a shock absorber connection part provided at the upper portion thereof and connected to the shock absorber 12, and a lower arm connection part provided at the lower portion thereof and connected to the lower arm 13.

Meanwhile, in the case of the above structure, when steering force is applied to the knuckle, there is a structural limitation in that steering force is applied to the wheel only when the knuckle is simultaneously rotated with a fixed knuckle.

The above information disclosed in this Background section is provided only to enhance understanding of the background of the disclosure, and therefore it may contain information that does not form the prior art that is already known to a person of ordinary skill in the art.

### SUMMARY

The present disclosure has been made in an effort to solve the above-described problems associated with the prior art, and it is an object of the present disclosure to provide a suspension coupling structure in which a steering shaft is divided into two steering axis using a rotating knuckle and a fixed knuckle, one steering axis is used to steer a vehicle, and the other steering axis formed from the fixed knuckle improves K&C performance (toe change control) so as to improve stability of the vehicle.

It is another object of the present disclosure to provide the rotating knuckle capable of performing rotation thereof through the fixed knuckle coupled only to the upper end of the rotating knuckle and a lower arm.

It is a further object of the present disclosure to provide a coupling structure in which the fixed knuckle and an upper arm are coupled to each other corresponding to a rotation center point.

The objects of the present disclosure are not limited to the above-mentioned objects, and other technical objects not mentioned herein should be clearly understood by those having ordinary skill in the art to which the present disclosure pertains from the detailed description of the embodiments. Additionally, the objects of the present disclosure may be achieved by means and combinations thereof as indicated in the claims.

In one aspect of the present disclosure, a suspension coupling structure includes: an upper arm including a first end connected to a vehicle body, a fixed knuckle connected to a second end of the upper arm, a rotating knuckle located at a lower end of the fixed knuckle and coupled to a wheel, and a steering input part fixed to the fixed knuckle and configured to apply a steering force to the rotating knuckle. The suspension coupling structure further includes: a lower arm including a first end connected to the vehicle body and a second end connected to a lower end of the rotating knuckle, and a toe link including a first end connected to the vehicle body and a second end connected to the fixed knuckle.

In an embodiment, the upper arm may be formed of two independent arms, and an intersection point between two virtual extension lines, each of the virtual extension lines connecting a connection point between a corresponding one of the two independent arms and the vehicle body to a connection point between the corresponding one of the two independent arms and the fixed knuckle, may be located on a steering rotation axis line.

In another embodiment, the steering input part may include an output shaft coupled to the rotating knuckle.

In still another embodiment, the suspension coupling structure may further include a shock absorber including a first end connected to the vehicle body and a second end connected to the lower arm.

In yet another embodiment, the rotating knuckle may be connected to the lower arm by a ball joint.

In still yet another embodiment, the upper arm may be connected to the fixed knuckle by a ball joint.

In a further embodiment, the toe link may be connected to a vehicle front side surface of the fixed knuckle.

In another further embodiment, when the wheel is bumped, the toe link may be configured to cause a change in toe of the wheel by moving a connection point between the toe link and the fixed knuckle to an inner side of a vehicle.

In still another further embodiment, the toe link may be connected to the vehicle body and the fixed knuckle by a ball joint.

In yet another further embodiment, the suspension coupling structure may further include a leaf spring including a first end connected to the vehicle body and a second end connected to the lower arm.

Other aspects and embodiments of the disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 is a view showing a coupling relationship of a rotating knuckle in the related art;

FIG. 2 is a perspective view of a suspension coupling structure according to an embodiment of the present disclosure;

FIG. 3 is a view showing a bottom configuration of the suspension coupling structure according to the embodiment of the present disclosure;

FIG. 4 is an enlarged view of a fixed knuckle of the suspension coupling structure according to the embodiment of the present disclosure;

FIG. 5 is a view showing a coupling structure of an upper arm coupled to the fixed knuckle according to the embodiment of the present disclosure;

FIG. 6A is a view showing a change in suspension structure when a vehicle is bumped according to an embodiment of the present disclosure; and

FIG. 6B is a view showing bump toe generated through a toe link when the vehicle is bumped according to an embodiment of the present disclosure.

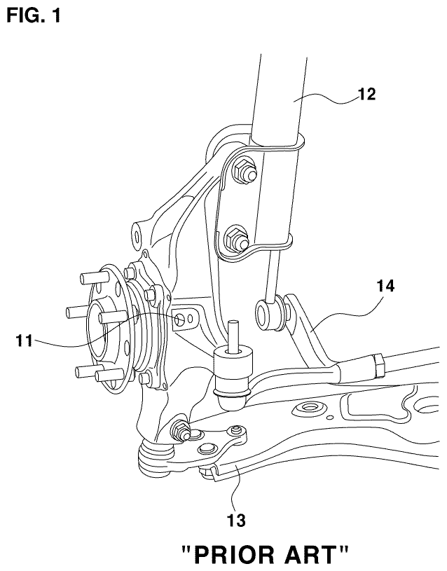

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes should be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. While the present disclosure is described in conjunction with some embodiments, it should be understood that present description is not intended to limit the present disclosure to the embodiments. On the contrary, the disclosure is intended to cover not only the following embodiments, but also various alternatives, modifications, equivalents, and other embodiments, which may be included within the spirit and scope of the disclosure as defined by the appended claims. The present embodiments are provided to more fully explain the present disclosure to those of ordinary knowledge in the art.

It should be understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles that are powered by fuel resources other than petroleum. As used herein, a hybrid vehicle refers to a vehicle that has two or more power sources, for example, vehicles powered by both gasoline and electricity.

Terms such as “knuckle”, “unit”, and “part” described in the present disclosure mean a unit configured to process at least one function or operation, and the “unit” may be implemented by hardware or software or a combination of hardware and software. When a component, device, element, or the like of the present disclosure is described as having a purpose or performing an operation, function, or the like, the component, device, or element should be considered herein as being “configured to” meet that purpose or to perform that operation or function.

Hereinafter, embodiments are described in detail with reference to the accompanying drawings. In describing the embodiments with reference to the accompanying drawings, the same or corresponding components are denoted by the same reference numerals and redundant description thereof has been omitted.

In addition, an “inner wheel” described in the present disclosure refers to a steering input that causes a wheel to be rotated rearwards in the longitudinal direction of the vehicle, and an “outer wheel” refers to a steering input that causes a wheel to be rotated forwards in the longitudinal direction of the vehicle.

In one embodiment of the present disclosure, a suspension coupling structure includes: a fixed knuckle 200, and a rotating knuckle 100 located inside the fixed knuckle 200. The rotating knuckle 100 is configured to be rotatable independently of the fixed knuckle 200.

Further, the suspension coupling structure is fasten to each wheel 800 so as to be steered independently. Here, the wheel 800 equipped with the corresponding suspension coupling structure may be configured to have a steering angle of 60 degrees for the outer wheel and 90 degrees for the inner wheel.

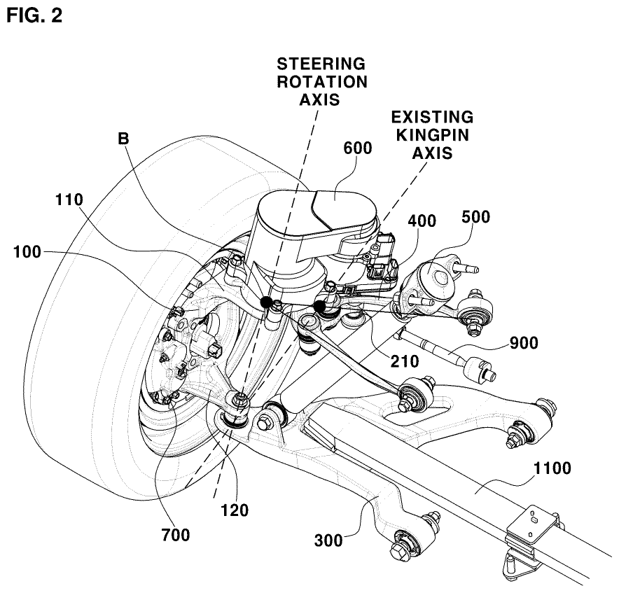

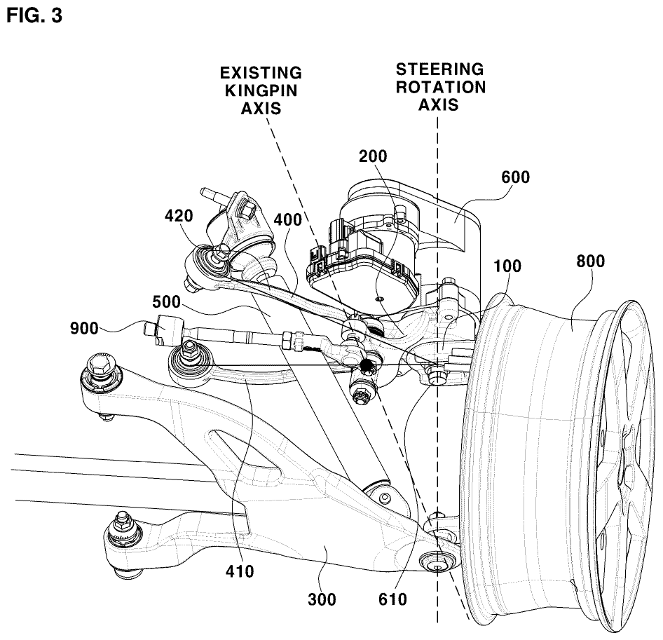

FIGS. 2 and 3 are views each showing a coupling relationship of the suspension coupling structure according to an embodiment of the present disclosure.

The suspension coupling structure further includes: a lower arm 300 coupled to a vehicle body or a frame and dispose in the width direction of the vehicle, and an upper arm 400 is configured to be located between the vehicle body and the fixed knuckle 200. The rotating knuckle 100 is coupled to one end of the lower arm 300, and the fixed knuckle 200 is configured to be located at the upper end of the rotating knuckle 100 . . . . The suspension coupling structure further includes a shock absorber 500 including a spring part. The shock absorber 500 includes one end located on the lower arm 300 and the other end located on the vehicle body through the upper arm 400.

The fixed knuckle 200 is coupled to the upper arm 400 and has a steering input part 600 located at the upper end thereof. Further, the fixed knuckle 200 is coupled to a toe link 900 so as to have a connection point with the toe link 900 on the rear side of the vehicle in the longitudinal direction. The rotating knuckle 100 is coupled to a rotation shaft (or an output shaft) of the steering input part 600 and is located at the lower end of the fixed knuckle 200. Furthermore, the toe link 900 may be configured to be coupled to the fixed knuckle 200 and the vehicle body by a ball joint.

In other words, the steering input part 600 configured to transmit a rotational force to the rotating knuckle 100 is located at the upper end of the fixed knuckle 200. One end of the upper arm 400 is coupled to the fixed knuckle 200, and the toe link 900 is located adjacent to the side surface of the one end of the fixed knuckle 200 to which the upper arm 400 is coupled. One end of the lower arm 300 is coupled to the rotating knuckle 100. Here, one side surface of the rotating knuckle 100 is fixed to the wheel 800 or may be formed to be integrated with the wheel 800. Furthermore, the upper arm 400 and the fixed knuckle 200 may be coupled to each other by a ball joint. In one embodiment, the toe link 900 may be located on the rear side surface of the fixed knuckle 200.

The toe link 900 is configured to have a predetermined angle relative to the width direction of the vehicle between the fixed knuckle 200 and the vehicle body. During vehicle braking, the toe link 900 may transition to a state that is horizontal with the width direction of the vehicle, and one end of the wheel 800 coupled to the toe link 900 may transition to a toe-in state. As shown in the drawing, the toe link 900 includes one end (e.g., a first end) connected to the fixed knuckle 200 and the other end (e.g., a second end) coupled to the vehicle body. Here, the first end of the toe link 900 is located in front of the second end in the longitudinal direction of the vehicle. Therefore, depending on a braking environment of the vehicle, the fixed knuckle 200 coupled to the toe link 900 is rotated outwards in the width direction of the vehicle. Through this rotation, the wheel may switch to the toe-in state.

As such, in one embodiment of the present disclosure, the toe link 900 is coupled to the rear end of the fixed knuckle 200 in the longitudinal direction. Here, the wheel 800 is moved away from the vehicle body in response to braking of the vehicle, thereby switching to the toe-in state.

In other words, the rotating knuckle 100 is located at the lower end of the fixed knuckle 200 and is configured to couple the fixed knuckle 200 to the lower arm 300. Further, one surface of the rotating knuckle 100 includes a wheel mounting part on which the wheel 800 is mounted. The rotating knuckle 100 may include a braking device located adjacent to the wheel 800. In one embodiment, the rotating knuckle 100, the wheel 800, and the braking device are configured to be integrally rotated.

Furthermore, a kingpin axis of the vehicle is formed along a coupling position of the upper arm 400 coupled to the fixed knuckle 200 and the lower arm 300 coupled to the rotating knuckle 100. At least one coupling point A at which the upper arm 400 and the fixed knuckle 200 face each other may be formed at an end portion of each arm constituting the upper arm 400. In the embodiment, two coupling points A are respectively provided at the two arms 410, 420 of the upper arm 400. In this case, an intersection point between two virtual extension lines respectively extending from the coupling points A may be configured to correspond to a rotation center point B of the steering input part 600.

The coupling point A of the upper arm 400 is formed in a different manner depending on the number of arms constituting the upper arm 400. A position extending from each of the arms constituting the upper arm 400 and facing the fixed knuckle 200 may be defined as the coupling point A. As an example, the upper arm 400 including two arms may have two different coupling points A. Here, a point at which each arm and the fixed knuckle 200 face each other in the longitudinal direction may be defined as the coupling point A. Here, the coupling point A is not limited to a position at which the upper arm 400 and the fixed knuckle 200 contact each other. The coupling point A means a position at which each of the arms constituting the upper arm 400 corresponds to the end of the fixed knuckle 200 in the longitudinal direction of the fixed knuckle 200.

In one embodiment, the suspension coupling structure includes a leaf spring 1100 located between the lower arm 300 and the vehicle body. The leaf spring 1100 performs a function of absorbing shock applied to the wheel and transmitting the same to the vehicle body.

The rotating knuckle 100 rotates upper and lower portions thereof around a central axis thereof. In particular, the upper portion 110 of the rotating knuckle 100 is configured to have the same rotation axis as a rotation axis of the steering input part 600 located on the fixed knuckle 200. In addition, when the lower portion 120 of the rotating knuckle 100 is coupled to the lower arm 300 by a ball joint, and driving force of the steering input part 600 is applied to the rotating knuckle 100, the rotating knuckle 100 is configured to rotate around a coupling position between the fixed knuckle 200 and the lower arm 300.

Furthermore, the steering input part 600 is configured to be coupled to the rotating knuckle 100 so as to apply a steering force thereto in response to a steering input from a user. In an embodiment of the present disclosure, the steering input part 600 may be configured as a steering motor configured to change the steering angle of the rotating knuckle 100 by receiving an electronic signal. The steering input part 600 may be located at the upper end of the rotating knuckle 100 and may be coaxially located with a rotation axis of the rotating knuckle 100.

According to the embodiment, when the steering input part 600 is formed as a steering motor, the rotating knuckle 100 and the steering motor may be fixed with each other, and the steering motor may be configured to rotate the rotating knuckle 100 in response to a steering input from a user.

The steering input part 600 and the rotating knuckle 100 are configured to penetrate the upper end of the fixed knuckle 200 and to be coupled to each other at the inside of the fixed knuckle 200. In one embodiment of the present disclosure, the steering input part 600 and the rotating knuckle 100 are coupled to each other through a rotation transmission unit so that a rotational force of the steering input part 600 is transmitted to the rotating knuckle 100. In one embodiment, the rotation transmission unit of the present disclosure may be coupled to the steering input part 600 through a ball joint provided around the rotation center axis of the steering input part 600. An inlet portion of the steering input part 600, which is coupled to the rotating knuckle 100 through the ball joint, may be located at the upper end of the rotating knuckle 100.

In one embodiment, the rotating knuckle 100 has a bearing provided at the upper end thereof. Specifically, the bearing may be inserted into one end of the rotating knuckle 100 so that the rotation transmission unit of the steering input part 600 is rotatably inserted into the one end, in which the rotating knuckle 100 and the fixed knuckle 200 face each other at the one end. Therefore, when the rotating knuckle 100 is rotated by the rotational force of the steering input part 600, the upper end of the rotating knuckle 100 is configured to be rotated in a low friction state relative to the upper end of the fixed knuckle 200.

One end of the lower arm 300 and the lower end of the rotating knuckle 100 are configured to be coupled to each other through a ball joint. Here, the lower arm 300 is rotated around the central axis in the height direction of the steering input part 600 to which the rotating knuckle 100 is coupled and is configured to absorb vertical movement applied from the wheel 800. Furthermore, the lower arm 300 has a degree of freedom of movement such that the other end of the lower arm 300 coupled to the lower end of the rotating knuckle 100 moves in the vertical direction relative to one end thereof coupled to the vehicle body.

Accordingly, the rotating knuckle 100 is rotatable independently of the fixed knuckle 200 and is rotatably moved relative to the lower end of the fixed knuckle 200 and one end thereof coupled to the lower arm 300, thereby inputting the steering angle of the wheel.

The toe link 900 has one end coupled to the vehicle body and the other end coupled to the side surface of the fixed knuckle 200 coupled to the upper arm 400. The toe link 900 is coupled to the fixed knuckle 200 through a nut. Furthermore, the toe link 900 may be configured to allow the other end thereof, which is coupled to the fixed knuckle 200, to be moved upwards and downwards in the height direction of the vehicle relative to one end thereof that is fixed to the vehicle body. Additionally, the toe link 900 may be moved forwards and rearwards in the longitudinal direction of the vehicle in response to vehicle movement. In response to the vehicle movement, a distance between the side end of the fixed knuckle 200, which is coupled to the toe link 900, and the vehicle body varies relatively, thereby enabling the wheel 800 coupled to the fixed knuckle 200 to switch to the toe-in state or the toe-out state. In one embodiment, the toe link 900 coupled to the vehicle body may be coupled to a member mount so as to be rotatable in the upward-and-downward direction and forward-and-rearward direction relative to the member mount.

The fixed knuckle 200 may include a first extension arm 210 coupled to the upper arm 400 and a second extension arm 220 coupled to the toe link 900. Here, the first extension arm 210 is formed to extend from a steering center point of the rotating knuckle 100 to the inside of the vehicle body. The second extension arm 220 is located on the side surface of the first extension arm 210 and is parallel to the first extension arm 210. In one embodiment of the present disclosure, the second extension arm 220 is disposed at the lower end of the side surface of the first extension arm 210 and is formed to extend toward the inside of the vehicle body in parallel with the first extension arm 210. In other words, the first extension arm and the second extension arm are parallel to each other, and the second extension arm is located on the side surface of the first extension arm in a state of being spaced apart therefrom in the height direction.

The toe link 900 may be positionally coupled to the fixed knuckle 200 so as to prevent interference with the wheel 800 and tire even if the inner wheel or outer wheel rotation angle at which the rotating knuckle 100 is rotated is 90 degrees. In the embodiment of the present disclosure, the rotation angle of the wheel 800 may be formed to range from −60 degrees to 90 degrees.

In other words, the upper arm 400 and the toe link 900 are configured to move integrally with the wheel 800 relative to end portions thereof coupled to the vehicle body. Here, the upper arm 400 and the toe link 900 are coupled to the fixed knuckle 200 so as to guide vertical movement of the wheel 800 depending on the bump or rebound state of a vehicle relative to the vehicle body.

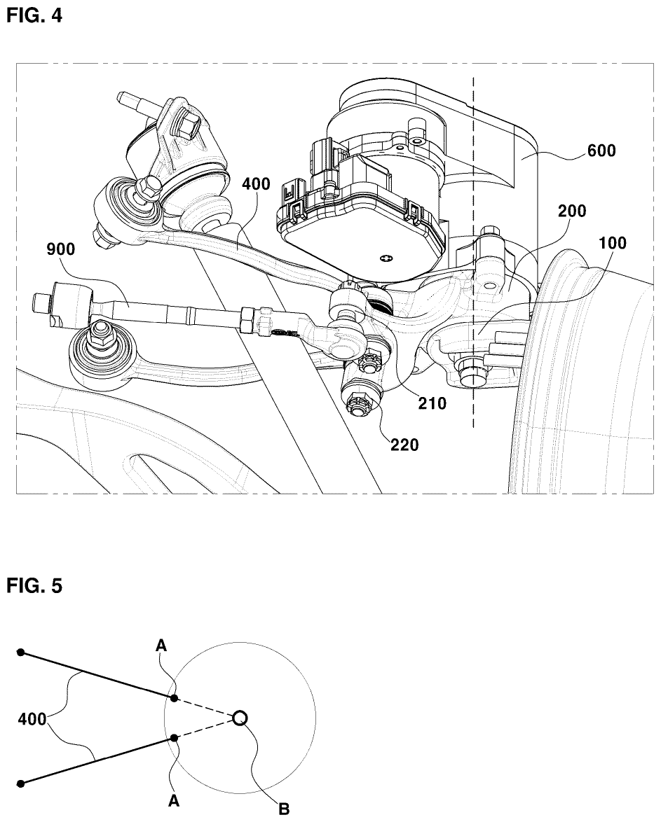

FIG. 4 shows the first extension arm 210 and the second extension arm 220 constituting the fixed knuckle 200 according to one embodiment of the present disclosure.

The fixed knuckle 200 is located between the upper end of the rotating knuckle 100 and the steering input part 600 and includes two arms extending toward the vehicle body. In one embodiment, the first extension arm 210 is coupled to the upper arm 400, and the second extension arm 220 is coupled to the toe link 900. The first extension arm 210 extends in a direction away from the rotating knuckle 100, and the second extension arm 220 is located on the side surface of the first extension arm 210 and is parallel to the first extension arm 210.

The toe link 900 is coupled to a portion of the fixed knuckle 200, in which the portion is laterally spaced from a rotation center point of the fixed knuckle 200. Moreover, the upper arm 400 coupled to the first extension arm 210 may be formed of a single arm or a dual arm. Here, the upper arm 400 may be located spaced apart from a rotation center point B of the steering input part 600 in a state of being located on an extension line extending from the vehicle body to the rotation center point B of the steering input part 600. Further, the rotation center point B of the steering center axis is formed on a rotation axis of the steering input part 600 and a coupling position between the rotating knuckle 100 coupled to the lower arm 300.

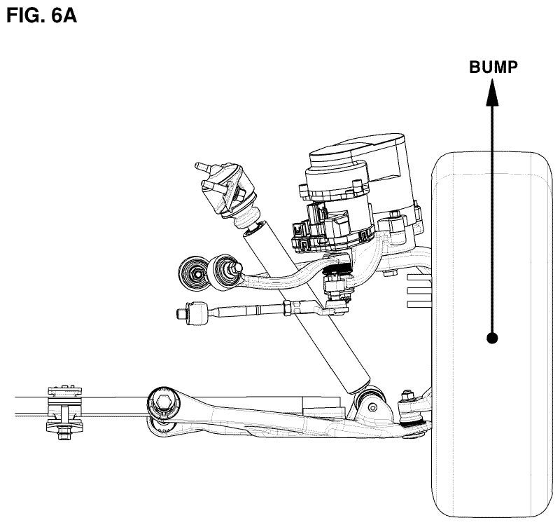

FIG. 5 shows a relationship between the upper arm 400 formed of two arms and the rotation center point B of the rotating knuckle 100.

The upper arm 400 coupled to the first extension arm 210 may include the two arms and may be coupled to the fixed knuckle 200. The upper arm 400 including the two arms is coupled to the first extension arm 210 of the fixed knuckle 200, and two coupling points A are respectively formed at the two arms of the upper arm 400.

Furthermore, the fixed knuckle 200 includes the rotation center point B that is coupled to the steering input part 600. As described above, the upper arm 400 includes two arms and is coupled to the fixed knuckle 200 in such a manner that, for example, when virtual extension lines are extended from the two coupling points A respectively formed at the two arms toward the fixed knuckle 200, the virtual extension lines contact each other at the rotation center point B.

In other words, the virtual extension lines of the upper arm 400 coupled to the fixed knuckle 200 are configured to correspond to the rotation center point B of the steering input part 600. Further, the upper arm 400 including the two arms is located in such a manner that, when virtual extension lines are extended from the respective coupling points A corresponding to the fixed knuckle 200, the virtual extension lines contact each other at the rotation center point B. In other words, the contact position becomes the rotation center point B.

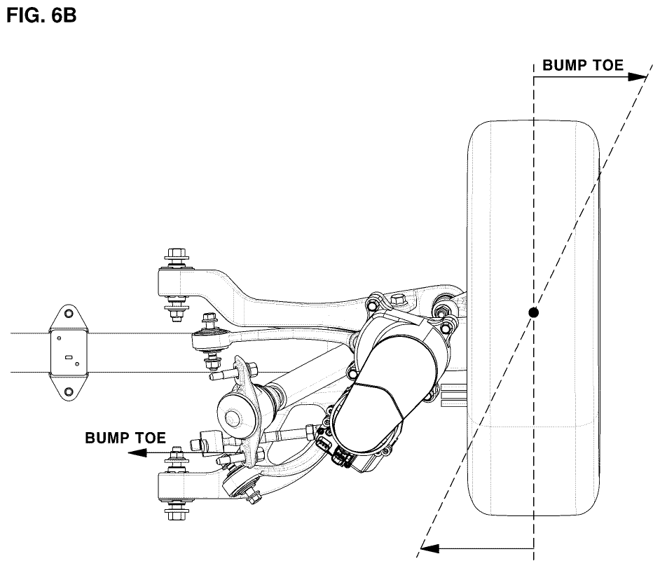

FIG. 6A is a side view showing a state in which a center point of a wheel is moved when a vehicle is bumped, and FIG. 6B is a top view showing bump toe generated through a toe link and applied to a wheel.

When a bump condition is applied in the height direction of a wheel during traveling of the vehicle, the rotating knuckle 100 and the fixed knuckle 200 are integrally moved upwards with the wheel in the height direction of the vehicle body. In this case, the toe link 900 is located to maintain a constant gap between the vehicle body and the fixed knuckle 200, and the fixed knuckle 200 moved in the height direction of the vehicle body is moved to a position relatively farther away from the vehicle body than a length of the toe link 900.

Therefore, when the fixed knuckle 200 is bumped upwards in the height direction in a state in which the toe link 900 is coupled to the fixed knuckle 200, bump toe occurs in a direction in which the side surface of the fixed knuckle 200 coupled to the toe link 900 approaches the vehicle body. When the toe link 900 is coupled to the rear end of the wheel in the longitudinal direction, toe out occurs in a direction in which the rear end of the wheel approaches the vehicle body.

As shown in FIG. 6B, in the bumped state, the fixed knuckle 200 is moved in a direction in which one side surface of the fixed knuckle 200, which is coupled to the toe link 900, becomes closer to the vehicle body. In other words, the rotating knuckle 100 coupled to the steering input part 600 is located in a state of not rotating around the fixed knuckle 200 and is integrally moved with the fixed knuckle 200 in a direction closer to the vehicle body in response to bump occurrence. Therefore, when the vehicle is bumped, bump toe may be applied to a wheel coupled to the rotating knuckle 100. In one embodiment, bump toe is generated in a direction in which the fixed knuckle 200 approaches the vehicle body relative to the kingpin axis formed in the suspension coupling structure.

As is apparent from the above description, the present disclosure may achieve the following effects through the above-described configuration, combination, and usage relationship.

First, a rotating knuckle is capable of rotating independently of a fixed knuckle thereby having an effect of providing a high degree of freedom in suspension movement. Second, an upper arm and a toe link are connected to the fixed knuckle so as to absorb vertical movement applied from a wheel to a suspension, thereby having an effect of achieving structural stability.

Third, it is possible to provide a suspension structure capable of achieving a low-floor vehicle through the configuration of the upper arm and the toe link connected to the fixed knuckle.

The present disclosure has been described in detail with reference to some embodiments thereof, and the present disclosure may be used in various other combinations, modifications, and environments. In other words, it should be appreciated by those having ordinary skill in the art that changes may be made in these embodiments without departing from the principles and spirit of the present disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A suspension coupling structure comprising:
an upper arm including a first end connected to a vehicle body;
a fixed knuckle connected to a second end of the upper arm;
a rotating knuckle located at a lower end of the fixed knuckle and coupled to a wheel;
a steering input part fixed to the fixed knuckle and configured to apply a steering force to the rotating knuckle;
a lower arm including a first end connected to the vehicle body and a second end connected to a lower end of the rotating knuckle; and
a toe link including a first end connected to the vehicle body and a second end connected to the fixed knuckle.

2. The suspension coupling structure of claim 1, wherein the upper arm is formed of two independent arms, and an intersection point between two virtual extension lines, each of the virtual extension lines connecting a connection point between a corresponding one of the two independent arms and the vehicle body to a connection point between the corresponding one of the two independent arms and the fixed knuckle, is located on a steering rotation axis line.

3. The suspension coupling structure of claim 1, wherein the steering input part includes an output shaft coupled to the rotating knuckle.

4. The suspension coupling structure of claim 1, further comprising a shock absorber including: a first end connected to the vehicle body and a second end connected to the lower arm.

5. The suspension coupling structure of claim 1, wherein the rotating knuckle is connected to the lower arm by a ball joint.

6. The suspension coupling structure of claim 1, wherein the upper arm is connected to the fixed knuckle by a ball joint.

7. The suspension coupling structure of claim 1, wherein the toe link is connected to a vehicle front side surface of the fixed knuckle.

8. The suspension coupling structure of claim 1, wherein when the wheel is bumped, the toe link is configured to cause a change in toe of the wheel by moving a connection point between the toe link and the fixed knuckle to an inner side of a vehicle.

9. The suspension coupling structure of claim 1, wherein the toe link is connected to the vehicle body and the fixed knuckle by a ball joint.

10. The suspension coupling structure of claim 1, further comprising a leaf spring including a first end connected to the vehicle body and a second end connected to the lower arm.
